(19) United States
(12) Patent Application Publication
(10) Pub. No.: US 2006/0051465 A1
(43) Pub. Date: Mar. 9, 2006

(54) Additive delivery laminate and packaging article comprising same

(75) Inventors: David R. Kyle, Moore, SC (US); Steven T. Calvert, Simpsonville, SC (US); Hillary Crawford, Simpsonville, SC (US); David Herndon, Moore, SC (US); Milissa Smith, Greer, SC (US)

Correspondence Address: Rupert B. Hurley Jr.;Sealed Air Corporation, P.O. Box 464, Duncan, SC, 29334, US

(73) Assignee: Cryovac, Inc.

(21) Appl. No.: 11/187,786

(22) Filed: Jul. 22, 2005

Related U.S. Application Data
(60) Provisional application No. 60/590,826, filed on Jul. 22, 2004.

(51) Int. Cl. B32B 27/08

(52) U.S. Cl. 426/127

(57) ABSTRACT

An additive delivery laminate is suitable for packaging a food product which is cooked in the package, with an additive transferring from the laminate to the food product. The additive delivery laminate has a substrate and an additive delivery layer. The additive delivery layer contains a water-insoluble thermoplastic polymer, a polymer toughening agent, and additive granules containing a colorant, flavorant, and/or odorant. The polymer toughening agent is present in a blend with the water-insoluble thermoplastic polymer. Polyisobutylene is a preferred water-insoluble thermoplastic polymer, and hydrogenated wood rosin is a preferred polymer toughening agent. The polymer toughening agent decreases the tendency of the water-insoluble thermoplastic polymer to form legs or transfer to the food product upon stripping the laminate from the food product after cooking and transfer to the additive to the food product.

### CROSS-REFERENCE TO RELATED APPLICATION

This application claims priority from parent U.S. Ser. No. 60/590,826, filed 22 Jul. 2004, which is hereby incorporated, in its entirety, by reference thereto.

### FIELD OF THE INVENTION

The present invention relates generally to packaging, and more specifically to thermoplastic laminates, and methods of using same especially to package and heat or cook a food product to deliver enhanced flavor, aroma, and/or color to the food product.

### BACKGROUND OF THE INVENTION

The commercial food packaging industry has for many years carried out processes in which a food additive is used to modify a food product by imparting a desired color, flavor, or odor to the product. In the meat industry, this has included modification of a meat product during cooking of the meat. Typically, smoke flavor and color, and caramel coloring, having been used to modify the meat product.

There remains a need to improve the manner in which color, flavor, and odor food additives are combined with food products, and to improve the quality of the resulting modified food product. Problems experienced in the prior art include, among others, uneven distribution of the food additive in or on the food product, inability to transfer enough food additive to the food product, inadequate adhesion of the food additive to the food product upon removing the package from the food product, and poor appearance of the food product after transfer of the food additive to the food product. It would be desirable to provide a process or product which addresses one or more of these areas.

### SUMMARY OF THE INVENTION

As a first aspect, the present invention is directed to a laminate comprising a substrate and an additive delivery layer. The additive delivery layer comprises a water-insoluble thermoplastic polymer, a polymer toughening agent, and additive granules. The polymer toughening agent is present in a blend with the water-insoluble thermoplastic polymer. The additive granules comprise at least one member selected from the group consisting of colorant, flavorant, and odorant.

If the substrate is present in the form of a film, it can be a monolayer film or a multilayer film. If a multilayer film, preferably the substrate may comprise a heat seal layer and an O₂-barrier layer. The multilayer film may further comprise an outer abuse layer, a first tie layers between the O₂-barrier layer and the seal layer, and a second tie layer between the O₂-barrier layer and the abuse layer. The multilayer film may further comprise a moisture barrier layer between the outer abuse layer and the O₂-barrier layer.

As a second aspect, the present invention is directed to a packaging article comprising the laminate according to the first aspect of the present invention. In the packaging article, the laminate is adhered to itself or another component of the packaging article. Preferred packaging articles include bag, pouch, casing, tray, thermoformed article, and lidding film. Preferred casings include seamless casing, fin-sealed backseamed casing, lap-sealed backseamed casing, and butt-sealed backseamed casing with backseaming tape thereon. The bag can be an end-seal bag, a side-seal bag, a U-seal bag (also referred to as a pouch), or an L-seal bag.

The additive transfer laminate of the present invention can be used in a process for preparing a cooked food product. The process includes packaging a food product in a packaging article comprising the laminate, with the food product being packaged so that the additive delivery layer is between the food product and the substrate. Upon cooking the food product in the package, for example at a temperature of from 45° C. to 200° C., at least a portion of the additive is transferred to the food product. The additive can also be transferred to the food product by immersing the packaged food product into a water bath at 200° F. for a period of 60 seconds.

In one embodiment, the additive delivery coating is applied to only a portion of the surface of the substrate, or applied to the substrate in a pattern, i.e. a logo, grill marks, etc., leaving no coating on those surfaces of the substrate layer which are to be heat sealed. The additive delivery coating can be formulated with a thermoplastic elastomeric polymer that adheres to the substrate.

### BRIEF DESCRIPTION OF THE DRAWINGS

FIG. 1 illustrates a schematic view of a process for making a substrate film in accordance with the present invention.

FIG. 2 illustrates a lay-flat view of a bag made from the additive transfer laminate in accordance with the present invention.

FIG. 3 illustrates a packaged product containing the additive transfer laminate in accordance with the present invention.

FIG. 4 illustrates a perspective view of an alternative packaged product containing the additive transfer laminate in accordance with the present invention.

FIG. 5 illustrates a first embodiment of a cross-sectional view through line 5-5 of the packaged product illustrated in FIG. 4.

FIG. 6 illustrates a cross-sectional view of an alternative packaged product.

FIG. 7 illustrates a cross-sectional view of another alternative packaged product.

FIG. 8 illustrates a schematic view of a process for coating a substrate film to make the additive delivery laminate of the invention

FIG. 9 is a cross-sectional view of a dried additive delivery coating layer made from a relatively homogeneous formulation.

FIG. 10 is a cross-sectional view of a dried additive delivery coating layer made from a relatively heterogeneous formulation.

### DETAILED DESCRIPTION OF THE INVENTION

The phrase “additive delivery layer” refers to a layer of the laminate which contains both the water-insoluble thermoplastic polymer, the polymer toughening agent, and additive-containing granules. In operation, the granules in the additive delivery layer transfer to the food product. Preferably, the additive delivery layer is prepared by combining the thermoplastic polymer, the polymer toughening agent, an organic solvent, and the additive granules, with the thermoplastic polymer and the polymer toughening agent being dissolved in the organic solvent, with the additive granules then being stirred into the solution. The resulting slurry is then deposited onto a substrate (which can, for example, be a film, either monolayer or multilayer), and the solvent evaporated, leaving the additive delivery coating affixed onto the substrate (i.e., bonded to the substrate), resulting in the additive delivery laminate. Upon evaporation of the solvent, the additive delivery layer can be present in an amount within the range of from about 5 to about 50 grams per square meter; or from about 10 to about 30 grams per square meter; or from about 10 to about 20 grams per square meter, or from about 20 to about 30 grams per square meter.

While the thermoplastic polymer of the additive delivery layer can optionally contain one or more water-soluble thermoplastic polymers (e.g., one or more polymers set forth in an optional “overcoat layer”, described below), the thermoplastic polymer of the additive delivery layer comprises at least one water-insoluble polymer. The water-insoluble thermoplastic polymer can made up 100% of the polymer of the additive delivery layer. If a blend of water-soluble polymer and water-insoluble thermoplastic polymer is present in the additive delivery layer, preferably the amount of water-soluble polymer is less than 50 percent, based on total weight of the water-insoluble thermoplastic polymer in the additive delivery layer, for example within a range of from about 1 to about 40 percent, or within from about 1 to 20 percent, or within from about 1 to about 10 percent, based on total weight of the water-insoluble thermoplastic polymer in the additive delivery layer.

The water-insoluble thermoplastic polymer preferably comprises at least one member selected from the group consisting of butadiene/styrene rubber, isobutylene/isoprene copolymer (e.g., butyl rubber), crosslinked butyl rubber, polyisoprene, polyisobutylene, polybutylene, styrene/isobutylene copolymer, ethylene/vinyl acetate copolymer, ethylene/vinyl alcohol copolymer, ethylene/propylene copolymer, propylene/ethylene copolymer, polypropylene, polybutadiene, polyethylene, ethylene/alpha-olefin copolymer, ethylene/cyclo-olefin copolymer, polyvinyl acetate, cellulose triacetate, natural rubber, chicle, and balata rubber.

Polyisobutylene and crosslinked butyl rubber are preferred water-insoluble thermoplastic plolymers for use in the additive delivery layer. Vistanex® MM L 80 polyisobutylene, Vistanex® MM L 100 polyisobutylene, Vistanex® MM L 120 polyisobutylene, Vistanex® MM L 140 polyisobutylene, and Kalar® 5263 crosslinked butyl rubber are suitable for use in the additive delivery layer. The polyisobutylene can have an intrinsic viscosity of from about 1 deciliter/gram to about 5 deciliters/gram, or from about 2 deciliters/gram to about 4.5 deciliters/gram, or from about 3 deciliters/gram to about 4 deciliters/gram.

As used herein, the phrase “polymer toughening agent” refers to a component which, when blended with the water-insoluble thermoplastic polymer, results in a blend which is tougher than the thermoplastic polymer in the absence of the toughening agent. The polymer toughening agent may produce a blend having higher modulus and/or higher cohesive strength and/or higher adhesive strength than the thermoplastic polymer in the absence of the toughening agent. The polymer toughening agent may be selected to produce a blend having a higher glass transition temperature (i.e., T_{g}) than the thermoplastic polymer without the toughening agent. One or more of various kinds of polymer toughening agents may be used in the laminate of the present invention.

Tackifiers can serve as polymer toughening agents in the additive delivery layer. A tackifier is a substance which when blended with the thermoplastic polymer produces a blend having a higher initial tack than the thermoplastic polymer in the absence of the toughening agent, and/or a greater tack range than possessed by the thermoplastic polymer in the absence of the polymer toughening agent. Tackifiers include terpene resin, polyterpene resin, rosin, and petroleum hydrocarbons. Exemplary of petroleum hydrocarbons are hydrocarbon resins, aliphatic resins, aromatic resins, hydrogenated hydrocarbon resins (both fully hydrogenated and partially hydrogenated), liquid resins (such as aromatic C9 type liquid resin), and mixed resins such as aliphatic/aromatic C5/C9 mixed feedstock resins.

Rosin includes rosin acids and rosin esters. Rosins are naturally occurring, are derived from pine trees, and contain unsaturation in the natural state. The unsaturation imparts instability to heat and oxidation. Hydrogenation renders rosins more stable to heat and oxidation. Rosins useful in the invention can be partially hydrogenated or fully hydrogenated. Examples of rosin include gum rosin (i.e., the pine gum harvested from living pine trees), wood rosin (derived from the heartwood of pine tree stumps), tall oil rosin (obtained by distillation of crude tall oil, which is a by-product of the pulping process), and rosin derivatives (such as rosin esters, including metallic salts of rosin esters). Rosin ester, hydrogenated rosin and partially hydrogenated wood rosin (particularly hydrogenated or partially hydrogenated wood rosin) are preferred tackifiers for the laminate of the present invention. Partially-hydrogenated and non-hydrogenated rosin can also be used as polymer toughening agents. However, hydrogenated rosins have greater heat stability than non-hydrogenated rosins.

Preferred rosins for use in the present invention include Foral® AX hydrogenated rosin, Foral® DX hydrogenated rosin, and Endere® S hydrogenated rosin ester.

Minerals (both inorganic and organic) can also server as polymer toughening agents in the additive delivery laminate. Both naturally-occurring minerals, processed minerals (e.g., purified minerals), and synthetic minerals are useful as polymer toughening agents in the laminate of the present invention. Calcium oxide can serve as a polymer toughening agent and/or release agent, as it has been found to reduce “legs”, i.e., to reduce the level of adhesion (and the level of transfer) of the water-insoluble polymer to the cooked food product upon separating the laminate from the food product after cooking. Pentaerythritol (i.e., tetramethylolmethane) and amber may also be used as polymer toughening agents. Silica (including fumed silica and amorphous silica), clay, talc, mica, and kaolin can serve as polymer toughening agents. The toughening agent can be present in the additive delivery layer in an amount of from about 0.1 to 30 weight percent, based on the weight of the thermoplastic polymer; or in an amount of from about 0.3 to 10 weight percent; or in an amount of from about 0.5 to 5 weight percent, based on the weight of the thermoplastic polymer.

The additive delivery layer may optionally further include one or more processing aids. Exemplary processing aids include substances which: (a) improve release of the additive from the additive delivery coating to the food product during heating, cooking, or reheating, (b) reduce adhesion of exposed surface of the additive delivery layer to the other outer surface of the laminate in the event that the laminate is wound into a roll for storage, and (c) improve the coefficient of friction (prevent blocking) of the coated laminate during manufacture, storage, and use of the laminate.

Processing aids include but not limited to, wax (including petroleum wax, paraffin, edible wax, bees wax, microcrystalline wax, polyolefin wax, amide wax, and oxidized polyethylene), various oils (including silicone oil, mineral oil, vegetable oil, lard), edible surfactant, and anti-fog agent, starch, and cellulose based polymers. The application of starch powder to the surface of the additive delivery layer can serve as an antiblocking agent, and can also serve to minimize the formation of legs.

Polymer toughening agents and processing aids can reduce undesired adhesion of the polymer to the food product when the laminate is stripped from the food product after transfer of the additive(s) to the food product. A polymer which adheres to the food product during stripping can exhibit “adhesive legs” during peeling of the laminate from the cooked food.

Adhesive legs are portions of an adhesive layer which strongly adhere to the adherend (e.g., the cooked food product). During separation of the adhesive layer (e.g., the additive delivery layer) from an object to which the adhesive is adhered, portions of the adhesive layer may adhere so strongly that they cause the adhesive material to stretch out to form visibly apparent connecting strands called “legs”. Adhesive legs are undesirable as they are present only if the polymer is adhering to the food. Legs are indicative of two potential undesirable consequences of adhesion of polymer to food product. The first undesirable consequence is transfer of pieces of polymer to the cooked food product. The second undesirable consequence is pulling pieces of food product off onto the laminate as it is being peeled from the cooked food product (e.g., “meat pull-off”). It is desirable for there to be few or no legs, no meat pull-off, and no transfer of polymer to meat product during stripping of the laminate from the cooked meat product.

Organic solvents useful in making the coating blend/solution include volatile hydrocarbon fluids selected from the group consisting of C₅ to C₁₂ alkanes and alkenes, aliphatic alcohols selected from the group consisting of C₃ to C₆ alcohols, ketones selected from the group consisting of C₃ to C₅ aliphatic ketones, and C₃ to C₁₂ organic esters. Pentane, hexane, heptane, octane, and iso-octane are suitable solvents. Optionally, the additive delivery laminate can further comprise an overcoat layer, i.e., a layer applied over the additive delivery layer. The overcoat layer should be water-soluble, and preferably comprises at least one member selected from the group consisting of polysaccharide and protein. More particularly, the overcoat layer comprises at least one member selected from the group consisting of alginate, cellulosic polymer, methyl cellulose, hydroxypropyl starch, hydroxypropylmethyl starch, hydroxymethyl cellulose, hydroxypropyl cellulose, hydroxypropylmethyl cellulose, carboxymethyl cellulose, cellulose esterified with 1-octenyl succinic anhydride, polyvinylalcohol, chitin, and chitosan, gliadin, glutenin, globulin, albumin (especially in the form of gluten), prolamin (especially corn zein), thrombin, pectin, carageenan, konjac flour-glucomannin, fibrinogen, milk protein, polysaccharide, casein (especially casein milk protein), soy protein, whey protein (especially whey milk protein), and wheat protein. The overcoating layer is optionally applied to assist in “clean” separation of the additive delivery coating from the food during the step of stripping away the laminate following heat processing.

As used herein, the term “substrate”, and the phrase “substrate layer” refer to the portion of the additive delivery laminate which supports the additive delivery layer. Although the substrate or substrate layer can be any article to which the additive delivery layer can be adhered, a preferred additive delivery layer is a thermoplastic article or a cellulosic article. A flexible film is a preferred article. The film can be a monolayer film or a multilayer film. Preferably, the substrate can be heat sealed by bringing uncoated portions of the heat seal layer together under heat and pressure to form a heat seal.

Preferably, the substrate comprises at least one member selected from the group consisting of polyolefin, polyethylene, ethylene/alpha-olefin copolymer, polypropylene, propylene/alpha-olefin copolymer, ethylene/vinyl acetate copolymer, ethylene/unsaturated ester copolymer, ethylene/alpha, beta-unsaturated carboxylic acid, ethylene/alpha, beta-unsaturated carboxylic acid anhydride, metal base neutralized salt of ethylene/alpha, beta-unsaturated carboxylic acid, ethylene/cyclo-olefin copolymer, ethylene/vinyl alcohol copolymer, polyamide, co-polyamide, polyester, co-polyester, polystyrene, polyvinylchloride, polyacrylonitrile, polyurethane, and cellulose.

Film substrates onto which the additive delivery layer is applied may include one or more additional layers, depending on the properties required of the film. Preferred substrates are multilayer films, designed to achieve slip, modulus, oxygen barrier, and heat sealability. Polymers useful in making the first layer of a multilayer substrate film include polyolefin, vinylidene chloride copolymer (including vinylidene chloride/vinyl chloride/methyl acrylate copolymer), ethylene homopolymer and copolymer (particularly ethylene/alpha-olefin copolymer), propylene homopolymer, polybutene, butene/alpha-olefin copolymers, ethylene/unsaturated ester copolymer (particularly ethylene/vinyl acetate copolymer), ethylene/unsaturated acid copolymer (including ethylene/acrylic acid copolymer), ethylene/vinyl alcohol copolymer, polyamide, co-polyamide, polyester, co-polyester, and ionomer.

Heat sealable substrate layers may include high density polyethylene (HDPE), high pressure low density polyethylene (LDPE), ethylene/alpha-olefin copolymers (LLDPE and VLDPE), single-site catalyzed ethylene/alpha-olefin copolymers (linear homogeneous and long chain branched homogeneous ethylene/C₃-C₁₀ alpha-olefin copolymers), interpenetrating network polymers (IPNs), substantially spherical homogeneous polyolefins (SSHPEs), polypropylene, polybutylene, butene/alpha-olefin copolymers, propylene/ethylene copolymer, and/or propylene/hexene/butene terpolymer. Additional film layers may be included, i.e., in addition to the seal layer. For example, an O₂-barrier layer (e.g., ethylene/vinyl alcohol copolymer, vinylidene chloride/methyl acrylate copolymer, and/or vinylidene chloride/vinyl chloride copolymer) may be utilized behind the seal layer of the substrate. Multilayer substrate films useful in practicing the invention include for example a first substrate layer of LLDPE, a second blend layer of 85% EVA and 15% HDPE, a third tie layer of maleic anhydride grafted-LLDPE, a fourth layer of ethylene/vinyl alcohol copolymer, a fifth blend layer of 50% nylon 6 and 50% 6/12 copolyamide, a sixth tie layer of maleic anhydride grafted-LLDPE, a seventh blend layer of 85% EVA and 15% HDPE, and an eighth outer layer of LLDPE. In such an example, layers 2-8 provide the substrate film with oxygen barrier and strength properties in addition to the heat seal property of the first substrate layer.

As used herein, the term “colorant” refers to a substance which imparts color to a product which otherwise would have a different color. Colorants include the various FD&C approves colorants, together with various other colorants. Preferably, the colorant comprises at least one member selected from the group consisting of caramel, maltose, beet powder, spice, soy granules, iron oxide, grape color extract, and carotene.

As used herein, the term “flavorant” refers to a substance that affects the sense of taste, and is synonymous with the noun “flavor”, and includes particulate flavorant additives that modify the flavor of a food composition. Flavorants include, but are not limited to, spices (dehydrated garlic, mustard, herbs), seasoning agents (honey mustard, cumin, paprika, chili, lemon, ginger, coriander, barbecue, dehydrated soy), baked, grilled (particularly chargrill flavorant), or roasted flavor components, fried flavorant (particularly dry fried flavorant), turkey pan drippings flavorant, dehydrated honey, dehydrated vegetable flavorants (tomato, onion, jalapeno, cayenne, chipotle chile, black pepper, habaneros), sea salt, and, smoke flavorant (hickory, applewood, or mesquite smoke), and encapsulated smoke oil. Flavorants may be obtained from suppliers such as Gold Coast, Red Arrow, or Master Taste.

As used herein, the term “odorant” refers to a substance perceptible to the sense of smell, i.e., a scent. Preferred odorants include those which emit a pleasant aroma (such as a fragrance), or a savory aroma. Odorants include powdered smoke,

As used herein, the term “granule”, “granular”, or “granular agent”, comprises agglomerates as well as single particles. For example, the granules may include granules within a range of from about 10 to about 500 microns, such as within a range of from about 15 to about 300 microns, or from about 50 to about 250 microns, or from about 70 to about 200 microns, or from about 75 to about 150 microns. Those of skill in the art appreciate that flavor particles may be useful in larger or smaller sizes, for instance cracked pepper can be larger than 500 micron. Granules as used herein include fine additive particles such as powders. Granules are usually solid, but may include liquid, e.g., the granules can include microencapsulated liquids, such as encapsulated smoke oil. Depending upon the process utilized for preparing the laminate, it may be advantageous to classify the additive granules, e.g., it may be advantageous to utilize granules having a maximum dimension of up to 75 microns, or a maximum dimension of up to 150 microns. Screening and air classification, among other processes, can be employed to classify the granules.

The additive granules can be present at relatively high loading levels, based on the total weight of the additive delivery layer. For example, the additive granules can make up from about 10 to about 90 weight percent of the total weight of the additive delivery layer. Alternatively, the additive granules can make up from about 25 to about 85 weight percent of the additive delivery layer, or from about 50 to about 85 weight percent of the total weight of the additive delivery layer.

The granules may form a portion of the outer surface of the additive delivery layer. The outer surface of the additive delivery layer is the surface of the additive-delivery layer which is not adhered to the substrate, i.e., the surface of the additive delivery layer which is oriented away from the substrate.

At least some of the granules may be adhered directly to the surface of the thermoplastic polymer, or attached to the thermoplastic polymer with an adhesive. At least some of the granules may form at least a portion of an outer surface of the additive layer. At least some of the granules may be partially coated or fully coated with the thermoplastic polymer. At least some of the granules may be partially or fully embedded within the additive delivery layer.

While the term “coated” is used herein with respect to granules no portion of which forms an outer surface of the additive delivery layer, the phrase “partially coated” is used with reference to granules a portion of which is coated and a portion of which forms a portion of the outer surface of the additive delivery layer.

Preferably, the granules extend above that surface of the thermoplastic polymer of the additive delivery layer which is opposite the substrate. While some of the granules may be adhered or embedded to the outer surface of the thermoplastic polymer of the additive delivery layer, other granules may be embedded underneath the outer surface(s) of the thermoplastic polymer of the additive delivery layer. A fully embedded granule which is water-soluble will dissolve from within the additive delivery layer if the water can reach the granule. It may require the dissolution of part or all of an adjacent granule in order for the water to reach a fully embedded granule. A granule which is completely surrounded by the thermoplastic polymer may not dissolve if the thermoplastic polymer does not allow water to reach the embedded granule. Nevertheless, many if not most or even all of the granules will dissolve if a high loading of granules is present in the additive delivery layer.

The color, aroma, and flavor granules as used herein refer to additives that modify the flavor, aroma, and color of a food composition, including but not limited to spices (such as dehydrated garlic, onion, mustard, herbs), seasoning agents (such as dehydrated honey, dehydrated soy sauce, cumin, chili, curry powder, dehydrated lemon, ginger, coriander), flavor concentrates (such as barbecue, grilled, baked, roasted flavor), dehydrated vegetable flavors (such as tomato, jalapeno, cayenne, chipotle, paprika habaneros), sea salt, and smoke flavor concentrates (such as glycoaldehyde, 2,6-dimethoxyphenol, guaiacol, or dehydrated hickory, applewood, and mesquite smoke), caramel, maltose, maltodextrin, beet powder, iron oxide, grape color extract, and carotene. Suppliers of color and flavor granules include vendors such as Gold Coast, Red Arrow, and Master Taste.

Powdered caramel is among the preferred additives for use in the present invention. Caramel 602, Caramel 603, Caramel 608, Caramel 622, Caramel 624, Caramel 625, Caramel 900 are among the preferred powdered caramels for use in the present invention.

The polymer components used to fabricate multilayer films according to the present invention may also contain appropriate amounts of other additives normally included in such compositions. These include slip agents such as talc, antioxidants, fillers, pigments and dyes, radiation stabilizers, antistatic agents, elastomers, and the like additives, as known to those of skill in the art of packaging films.

Although the substrate need not be crosslinked, in at least one embodiment, one or more layers of the substrate are crosslinked. Crosslinking may be accomplished by conventional methods including irradiation and the addition of chemical crosslinking agents, as for instance agents initiating free radical reactions when heated or exposed to actinic radiation. In irradiation crosslinking, the laminate is subjected to an energetic radiation treatment, such as corona discharge, plasma, flame, ultraviolet, X-ray, gamma ray, beta ray, and high energy electron treatment, which may alter the surface of the film and/or induce cross-linking between molecules of the irradiated material. The irradiation of polymeric films is disclosed in U.S. Pat. No. 4,064,296, to BORNSTEIN, et. al., which is hereby incorporated in its entirety, by reference thereto. BORNSTEIN, et. al. discloses the use of ionizing radiation for crosslinking polymer present in the film.

Radiation dosages are referred to herein in terms of the radiation unit “RAD”, with one million RADS, also known as a megarad, being designated as “MR”, or, in terms of the radiation unit kiloGray (kGy), with 10 kiloGray representing 1 MR, as is known to those of skill in the art. To produce crosslinking, the polymer is subjected to a suitable radiation dosage of high energy electrons, preferably using an electron accelerator, with a dosage level being determined by standard dosimetry methods. A suitable radiation dosage of high energy electrons is in the range of up to about 16-166 kGy, more preferably about 30-139 kGy, and still more preferably, 50-100 kGy. Preferably, irradiation is carried out by an electron accelerator and the dosage level is determined by standard dosimetry methods. The radiation is not limited to electrons from an accelerator since any ionizing radiation may be used. A preferred amount of radiation is dependent upon the laminate and its end use.

The substrate can also be corona treated. As used herein, the phrases “corona treatment” refers to subjecting the surfaces of thermoplastic materials, such as polyolefins, to corona discharge, i.e., the ionization of a gas such as air in close proximity to a film surface, the ionization initiated by a high voltage passed through a nearby electrode, and causing oxidation and other changes to the film surface, such as surface roughness.

A relatively high loading of water soluble granules in thermoplastic polymer, for example in an amount within the range of from about 20% to about 900% by weight, based on weight of thermoplastic polymer (or from about 50% to 500%, or from about 150% to 350%), is preferably prepared by first dissolving the thermoplastic polymer in an organic solvent, and thereafter adding the granules to the solution to make a slurry comprising the additive granules dispersed in the solution of the thermoplastic water insoluble polymer. This slurry, when applied to the substrate followed by evaporation of the organic solvent, produces a coating on the substrate which becomes the additive delivery layer of the resulting laminate. The evaporation of the organic solvent results in a continuous matrix of the thermoplastic polymer, in which some of the additive granules are embedded below the surface of the thermoplastic polymer, while other additive granules are adhered to the surface of the thermoplastic polymer, these granules projecting above the outer surface of the thermoplastic polymer. Water-soluble granules that are partly or fully dissolved while in contact with a moisture-containing food product transfer additive to the food product.

As used herein, the term “film” is used in a generic sense to include plastic web, regardless of whether it is film or sheet. Preferably, films of and used in the present invention have a thickness of 0.25 mm or less. As used herein, the term “package” refers to packaging materials configured around a product being packaged. The phrase “packaged product,” as used herein, refers to the combination of a product that is surrounded by a packaging material.

As used herein, the phrase “laminate” refers to an article having at least two layers. Examples include multilayer film, such as coextruded multilayer film, extrusion coated multilayer film, a monolayer film having a coating thereon, and a multilayer film having a coating thereon, two films bonded with heat or an adhesive, etc. A preferred laminate comprises a substrate layer which is an outer layer of the substrate and which comprises a thermoplastic polymer, and an additive delivery layer, the additive delivery layer comprising a water-insoluble thermoplastic polymer impregnated with granules comprising water soluble colorant, water-soluble odorant, and/or water-soluble flavorant. The substrate layer of the laminate is preferably directly adhered to the additive delivery layer. The substrate film can optionally contain one or more additional film layers, such as an oxygen-barrier layer with or without tie layers in association therewith, additional bulk and/or strength layers, etc. The additive delivery layer is preferably a water permeable layer, i.e. permits water extraction of additives from the additive delivery layer for delivery to an adjacent packaged food. The second additive delivery layer is preferably applied as a coating onto the first substrate film layer.

As used herein, the phrase “outer layer” refers to any layer having less than two of its principal surfaces directly adhered to another layer of the film. The phrase is inclusive of monolayer and multilayer films and laminates. All laminates and all multilayer films have two, and only two, outer layers. Each outer layer has only one of its two principal surfaces adhered to only one other layer of the laminate or multilayer film. In monolayer films, there is only one layer, which, of course, is an outer layer in that neither of its two principal surfaces is adhered to another layer of the film.

As used herein, the phrase “drying,” as used with reference to the process of making the additive delivery laminate, refers to the removal of the organic solvent from the additive delivery slurry to form the additive delivery layer of the laminate. The drying converts the coating of additive delivery slurry on the substrate into a solidified additive delivery layer. The drying can result in an additive delivery layer that does not exhibit substantial blocking, i.e., to avoid sticking to a degree that blocking or delamination occurs, with respect to adjacent surfaces of, for example, a film (including both the same or another film), and/or other articles (e.g., metal surfaces, etc.). Preferably, the dried additive delivery layer has a hydrocarbon solvent content of less than about 5 percent, based on the weight of the outer layer; more preferably, from about 0.0001 to 5 percent; still more preferably, from about 0.0001 to 1 percent; yet more preferably, about 0 percent.

As used herein, the term “seal”, refers to any seal of a first region of a film surface to a second region of the same or another film surface, the seal typically formed by bringing the regions together under pressure and heating each of the film regions to at least their respective seal initiation temperatures to form a heat seal. The sealing can be performed by any one or more of a wide variety of manners, such as using a heated bar, hot air, infrared radiation, ultrasonic sealing, etc., and even the use of clips on, for example, a shirred casing, etc.

As used herein, the phrase “cook-in” refers to the process of cooking a product packaged in a material capable of withstanding exposure to long and slow cooking conditions while containing the food product. The cooked product can be distributed to the customer in the original package, or the packaging material can be removed and the food portioned for repackaging. Cook-in includes cooking by submersion in water at 57° C. to 85° C. for 2-12 hours, or by submersion in water or immersion in pressurized steam (i.e. retort) at 85° C. to 121° C. for 2-12 hours, using a film suitable for retort end-use. However, cook-in can include dry heat, i.e. conventional oven temperatures of 300° F. to 450° F., or microwave cooking, steam heat, or immersion in water at from 135° F. to 212° F. for 2-12 hours. Cooking often involves stepped heat profiles.

Preferably, the food is cooked at a temperature of from about 145° F. to 205° F. for a duration of from about 1 to 12 hours. Alternatively, the food product can be cooked at a temperature of from about 170° F. to 260° F. for a duration of from about 1 to 20 minutes, followed by cooking the food product at a temperature of from about 145° F. to 205° F. for a duration of from about 1 to 12 hours.

Preferably, the food product comprises at least one member selected from the group consisting of beef, pork, chicken, turkey, fish, cheese, tofu, and meat-substitute.

Cook-in packaged foods are essentially pre-packaged, pre-cooked foods that may be directly transferred to the consumer in this form. These types of foods may be consumed with or without warming. Cook-in packaging materials maintain seal integrity, and in the case of multilayer films are delamination resistant. In certain end-uses, such as cook-in casings, the laminate is heat-shrinkable under cook-in conditions so as to form a tightly fitting package. Additional optional characteristics of films for use in cook-in applications include delamination-resistance, low O₂-permeability, heat-shrinkability representing about 20-50% biaxial shrinkage at about 185° F., and optical clarity.

During cook-in, the package should maintain seal integrity, i.e., any heat-sealed seams should resist rupture during the cook-in process. Typically, at least one portion of a cook-in film is heat sealable to another portion to form a backseamed tubular casing, or a seamless tubing is used if a seamless casing is being used. Typically, each of the two ends of the tubular casing are closed using a metal clip. The casing substantially conforms to the product inside the casing. Substantial conformability is enhanced by using a heat-shrinkable film about the package contents so as to form a tightly fitting package. In some embodiments, the film is heat-shrinkable under time-temperature conditions of cook-in, i.e., the film possesses sufficient shrink energy such that exposure of the packaged food product to heat will shrink the packaging film snugly around the packaged product, representatively up to about 55% monoaxial or biaxial shrinkage at 185° F. In this manner, product yield is increased by the food product retaining moisture, and the aesthetic appearance of the packaged product is not diminished by the presence of the surface fluids or “purge”.

As used herein, the phrase the term “elevated temperature” as regards the process of heat processing a packaged food product (either cooked or uncooked) above ambient temperature to initiate the delivery of granular additives, refers to the heat treating of a packaged food above ambient temperature in a material capable of withstanding exposure to heat and time conditions while containing the food product, for example heating the food product to a temperature of from about 45° C. to about 250° C., such as from about 50° C. to about 200° C., or from about 55° C. to about 150° C., or about 57° C. to about 125° C., or about 60° C. to about 115° C., or about 65° C. to about 100° C., or such as about 70° C. to about 85° C. Elevated temperature processing of a packaged food may included stepped heat profiles, for example heating at 57° C. for 30 minutes, followed by heating at 60° C. for 30 minutes, followed by heating to 75° C. until reaching the desired internal food temperature.

The additive delivery laminate is useful for packaging both uncooked food product and cooked food product. That is, cooking an uncooked food product packaged in the additive delivery laminate can result in the additive being transferred to the food product during cooking. However, the additive delivery laminate can also be used to package a cooked food product, with the additive transferring to the cooked food product during reheating of the food product. Post-pasteruization conditions can be used to transfer the additive to an already cooked food product.

Laminates useful in the present invention may include monolayer or multilayer substrate films. The substrate film may have a total of from 1 to 20 layers; such as from 2 to 12 layers; or such as from 4 to 9 layers. The substrate film can have any total number of layers and any total thickness desired, so long as the substrate provides the desired properties for the particular packaging operation in which the film is used, e.g. O₂-barrier characteristics, free shrink, shrink tension, optics, modulus, seal strength, etc.

As used herein, the phrases “inner layer” and “inside layer” refer to an outer film layer, of a laminate packaging film contacting a product, or an article suitable for use in packaging a product (such as a bag or casing), which is closest to the product, relative to the other layers of the multilayer film.

As used herein, the phrase “outside layer” refers to the outer layer, of a multilayer film or laminate packaging a product, or an article suitable for use in packaging a product (such as a bag or casing), which is furthest from the product relative to the other layers of the multilayer film.

As used herein, the phrase “free shrink” refers to the percent dimensional change in a 10 cm×10 cm specimen of film, when shrunk at 185° F., with the quantitative determination being carried out according to ASTM D 2732, as set forth in the 1990 Annual Book of ASTM Standards, Vol. 08.02, pp. 368-371, which is hereby incorporated, in its entirety, by reference thereto. A heat-shrinkable film has a free shrink of from about 5-70 percent each direction (i.e., from about 5 to 70 percent in the longitudinal (L) and from about 5 to 70 percent the transverse (T) directions) at 90° C., or at least 10 percent at 90° C. in at least one direction; such as from about 10-50 percent at 90° C.; or from about 15-35 percent at 90° C. For conversion to bags and casings, the film article is monoaxially oriented or biaxially oriented, and preferably has a free shrink, at 90° C., of at least 10 percent in each direction (L and T); such as at least 15 percent in each direction. For casing end use, a film has a total free shrink (L+T) of from about 30 to 50 percent at 85° C. For bag end-use, a film has a total free shrink of at least 50% (L+T), such as from 50 to 120%. Alternately, the oriented film article can be heat-set. Heat-setting can be done at a temperature from about 60-200° C., such as 70-150° C. and, such as 80-90° C.

The substrate film used in the present invention can have any total thickness desired, so long as the film provides the desired properties for the particular packaging operation in which the film is used. Preferably, the substrate film used in the present invention has a total thickness, of from about 0.3 to about 15 mils (1 mil=0.001 inch; 25.4 mils=1 mm); such as from about 1 to about 10 mils; or from about 1.5 to about 8 mils. For shrinkable casings, the range from 1.5-8 mils is an example of an acceptable substrate film thickness.

Exemplary substrates which can be coated with the additive delivery coating formulation in accordance with the present invention, which can thereafter be used in accordance with the present invention, include the films disclosed in: (a) U.S. Serial No. 5,843,502, issued Dec. 1, 1998, in the name of Ram K. Ramesh; (b) U.S. Pat. No. 6,764,729, issued Jul. 20, 2004, in the name of Ram K. Ramesh; (c) U.S. Pat. No. 6,117,464 in the name of Moore, issued Sep. 12, 2000; (d) U.S. Pat. No. 4,287,151, to ESAKOV, et. al., issued Sep. 1, 1981; and (e) U.S. Ser. No. 617,720, in the name of Beckwith et al., filed Apr. 1, 1996. Each of these documents is hereby incorporated in its entirety, by reference thereto.

The following multilayer structures are exemplary of a variety of layer arrangements of additive delivery laminates. The “coating” layer is the additive delivery layer containing the combination of the additive-containing granules, the water-insoluble thermoplastic polymer, and the polymer toughening agent. All of the layers other than the coating layer represent the substrate portion of the additive delivery laminate. In the following film structures, the individual layers are shown in the order in which they would appear in the laminate.

seal/coating (food-contact)
abuse/seal/coating (food-contact)
abuse/barrier/seal/coating (food-contact)
abuse/tie/barrier/tie/seal/coating (food-contact)
abuse/tie/barrier/tie/bulk/seal/coating (food-contact)
abuse/bulk/tie/barrier/tie/bulk/seal/coating (food-contact)

The foregoing representative film structures are intended to be illustrative only and not limiting in scope.

The heat seal layer can have a thickness of from about 0.1 to about 4 mils, or from about 0.2 to about 1 mil, or from about 0.3 to about 0.8 mil. The outer abuse layer can have a thickness of from about 0.1 to about 5 mils, or from about 0.2 to about 3 mils, or from about 0.3 to about 2 mils, or from about 0.5 to about 1.5 mils. Preferably, the outer abuse layer comprises at least one member selected from the group consisting of polyolefin, polystyrene, polyamide, polyester, polymerized ethylene vinyl alcohol (i.e., hydrolyzed ethylene vinyl acetate copolymer), polyvinylidene chloride, polyester, polyurethane, and polycarbonate

The substrate can optionally comprise an O₂-barrier layer. The O₂-barrier layer is an internal layer of a substrate that is between the seal layer and the abuse layer of the substrate material. The O₂-barrier layer comprises a polymer having relatively high O₂-barrier characteristics. The O₂-barrier layer can have a thickness of from about 0.05 to 2 mils, and can comprise at least one member selected from the group consisting of polymerized ethylene vinyl alcohol (EVOH, which is hydrolyzed ethylene vinyl acetate copolymer), polyvinylidene chloride (including vinylidene chloride/methyl acrylate copolymer and J vinylidene chloride/vinyl chloride copolymer), polyamide, polyester, polyacrylonitrile, and polyacarbonate.

A multilayer substrate film may optionally further contain a tie layer, also referred to by those of skill in the art as an adhesive layer. The function of a tie layer is to adhere film layers that are otherwise incompatible in that they do not form a strong bond during coextrusion or extrusion coating. Tie layer(s) suitable for use in the film according to the present invention have a relatively high degree of compatibility with (i.e., affinity for) the O₂-barrier layer such as polymerized EVOH, polyamide, etc., as well as a high degree of compatibility for non-barrier layers, such as polymerized ethylene/alpha-olefin copolymers. In general, the composition, number, and thickness of the tie layer(s) is as known to those of skill in the art. Preferably, the tie layer(s) each have a thickness of from about 0.01 to 2 mils. Tie layer(s) each comprise at least one member selected from the group consisting of modified polyolefin, ionomer, ethylene/unsaturated acid copolymer, ethylene/unsaturated ester copolymer, polyamide, and polyurethane.

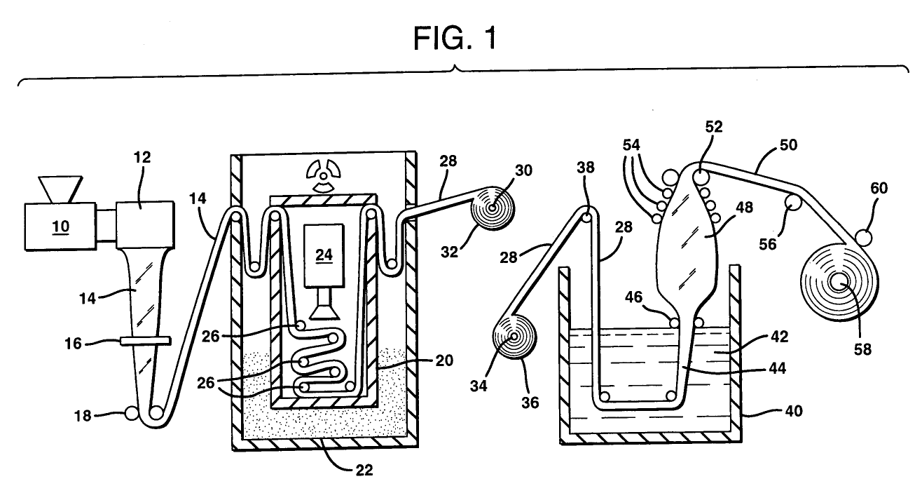

FIG. 1 illustrates a process for making a “substrate film” which can thereafter be coated so that it becomes a film in accordance with the present invention. In the process illustrated in FIG. 1, various polymeric formulations solid polymer beads (not illustrated) are fed to a plurality of extruders (for simplicity, only one extruder is illustrated). Inside extruders 10, the polymer beads are degassed, following which the resulting bubble-free melt is forwarded into die head 12, and extruded through an annular die, resulting in tubing tape 14 which is preferably from about 15 to 30 mils thick, and preferably has a lay-flat width of from about 2 to 10 inches.

After cooling or quenching by water spray from cooling ring 16, tubing tape 14 is collapsed by pinch rolls 18, and is thereafter fed through irradiation vault 20 surrounded by shielding 22, where tubing 14 is irradiated with high energy electrons (i.e., ionizing radiation) from iron core transformer accelerator 24. Tubing tape 14 is guided through irradiation vault 20 on rolls 26. Preferably, tubing tape 14 is irradiated to a level of from about 40-100 kGy, resulting in irradiated tubing tape 28. Irradiated tubing tape 28 is wound upon windup roll 30 upon emergence from irradiation vault 20, forming irradiated tubing tape coil 32.

After irradiation and windup, windup roll 30 and irradiated tubing tape coil 32 are removed and installed as unwind roll 34 and unwind tubing tape coil 36, on a second stage in the process of making the tubing film as ultimately desired. Irradiated tubing 28, being unwound from unwind tubing tape coil 36, is then passed over guide roll 38, after which irradiated tubing 28 is passed through hot water bath tank 40 containing hot water 42. Irradiated tubing 28 is then immersed in hot water 42 (preferably having a temperature of about 85° C. to 99° C.) for a period of about 20 to 60 seconds, i.e., for a time period long enough to bring the film up to the desired temperature for biaxial orientation. Thereafter, hot, irradiated tubular tape 44 is directed through nip rolls 46, and bubble 48 is blown, thereby transversely stretching hot, irradiated tubular tape 44 so that oriented film tube 50 is formed. Furthermore, while being blown, i.e., transversely stretched, nip rolls 52 have a surface speed higher than the surface speed of nip rolls 46, thereby resulting in longitudinal orientation. As a result of the transverse stretching and longitudinal drawing, oriented film tube 50 is produced, this blown tubing preferably having been both stretched in a ratio of from about 1:1.5 to 1:6, and drawn in a ratio of from about 1:1.5 to 1:6. More preferably, the stretching and drawing are each performed at a ratio of from about 1:2 to 1:4. The result is a biaxial orientation of from about 1:2.25 to 1:36, more preferably, 1:4 to 1:16. While bubble 48 is maintained between pinch rolls 46 and 52, trapped bubble 50 is collapsed by converging pairs of parallel rollers 54, and thereafter conveyed through pinch rolls 52 and across guide roll 56, and then rolled onto wind-up roll 58. Idler roll 60 assures a good wind-up. Before windup, the film can optionally be annealed by being heated to an elevated temperature, such as 170° F., while being restrained from shrinking. Annealing can occur even if the film is heated for only a short period of time, such as 15 seconds.

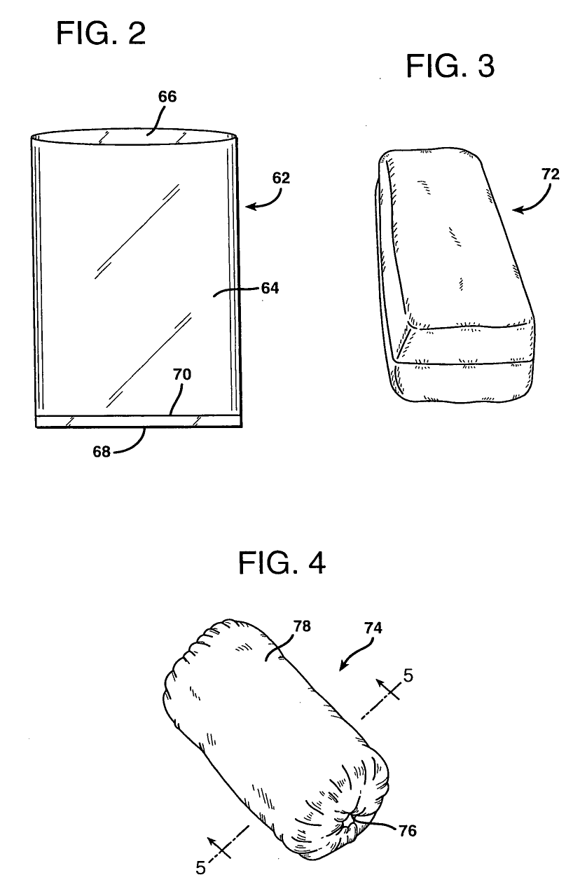

FIG. 2 illustrates bag 62 in lay-flat configuration. Bag 62 is made from film 64, and has open top 66, as well as bottom 68 closed by end-seal 70. Bag 62 has an additive delivery coating on the inside surface thereof (not illustrated) the coating being the inside layer of film 64. An uncooked food product, such as a meat product, is placed inside bag 62, with bag 62 thereafter being evacuated (i.e., vacuumized, to remove the air) and sealed, resulting in packaged meat product 72 illustrated in FIG. 3. The product, which is surrounded by the film, is thereafter cooked while remaining in the film. During cooking, the additive is delivered from the additive delivery layer of the laminate to the outer surface of the cooked product.

FIG. 4 illustrates another embodiment of a packaged product 74 of the present invention, the product being packaged in a casing closed by a pair of clips 76 at each end thereof, with only one clip being illustrated in the perspective view of FIG. 4. Film 78, used to package the meat product inside the casing, can be, for example, Film No. 1 or Film No. 2, discussed in detail below.

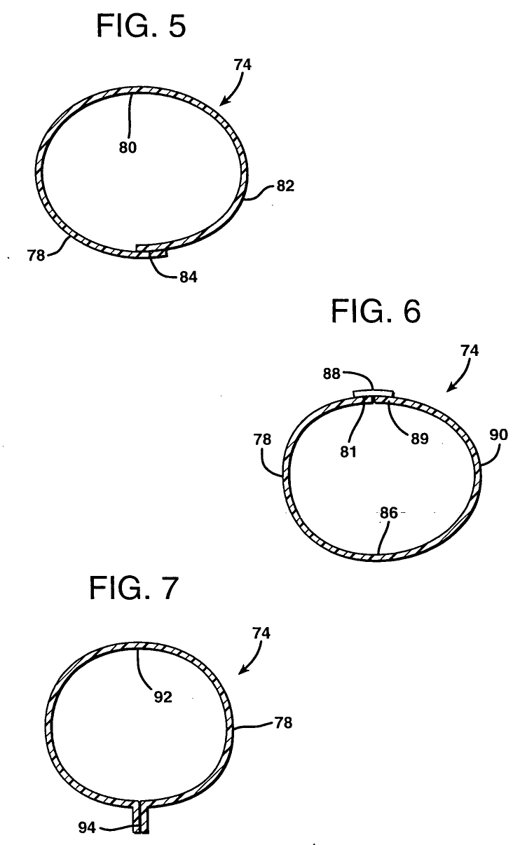

FIG. 5 illustrates a first cross-sectional view of packaged product 74, i.e., taken through line 5-5 of FIG. 4. FIG. 5 represents a cross-sectional view of a lap-sealed casing comprising film 78 having a coated inside surface region 80, with an uncoated portion heat sealed to outside surface 82 at heat seal 84, the heat seal being located where a first film region overlaps a second film region.

FIG. 6 illustrates an alternative cross-sectional view of packaged product 74, i.e., analogous to the view of FIG. 5 but for a butt-sealed backseamed casing. FIG. 6 represents a cross-sectional view of a butt-sealed backseamed casing comprising film 78 having a coated inside surface region 86. Casing film 78 is heat sealed to butt-seal tape 88. Casing film 78 has inside surface 86 and outside surface 90. Outside surface 90 is heat-sealed to butt-seal tape 88 at seals 87 and 89, where each of the edges of casing film 78 are abutted in close proximity to one another. In this manner, butt-seal tape 88 provides a longitudinal seal along the length of butt-sealed casing film 78. Although butt-seal tape 88 can be made from a monolayer film or a multilayer film, preferably butt-seal tape 88 is preferably made from a multilayer film.

FIG. 7 illustrates a cross-sectional view of a third alternative of packaged product 74, i.e., a fin-sealed backseamed casing. In FIG. 7, fin-sealed casing film 78 has a coated inside surface region 92. Along the edges of the inside surface of casing film 78 are two uncoated regions which are heat sealed to one another at seal 94, which forms a “fin” which extends from casing 74.

The laminate of the present invention can be manufactured using a modified printing or coating process. The additive delivery coating can be applied to a film substrate using printing technology, such as gravure coating or printing, lithographic coating or printing, flood coating followed by metering with a doctor blade, spray coating, etc. Preferably, the coating composition is applied to the film using at least one member selected from the group consisting of gravure roll, flexographic roll, Meyer rod, reverse angle doctor blade, knife over roll, reverse roll coating (including 2-roll, 3-roll, and 4-roll reverse coating), air knife coating, curtain coating, comma roll, lip coating, extrusion coating, spray coating, and screen printing (including rotary screen printing). Screen printing is capable of providing coating weights of from about 15 to about 40 grams/sq. meter. Moreover, screen printing (particularly rotary screen printing) can be used for pattern coating, which will allow manufacture of a backseamed or centerfolded bag.

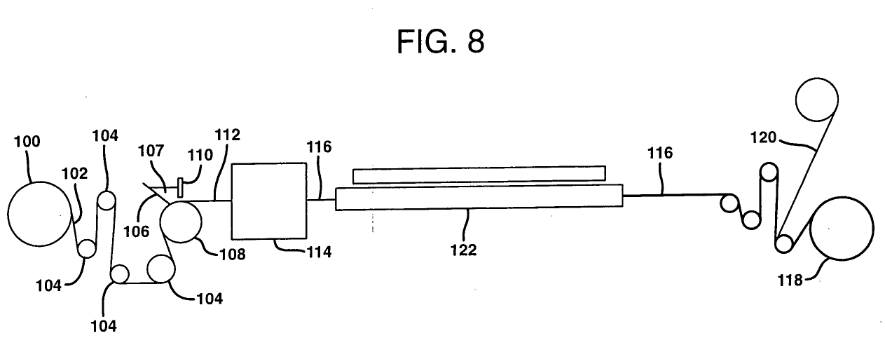

FIG. 8 is a schematic of a knife-over roll process for continuously coating a substrate with an additive delivery slurry, to make an additive delivery laminate. In the schematic process illustrated in FIG. 8, substrate roll 100 supplies substrate film 102 past rollers 104 to knife-over-roll coating apparatus consisting of formulation hopper 106 containing coating formulation 107, roll 108, and knife 110. The resulting coated substrate 112 passes through dryer 114 wherein the solvent is evaporated. The resulting dried additive delivery laminate 116 can then be rolled up onto windup roll 118. However, as even the dried coating can cause the laminate 116 to block to itself, sacrificial interleafing film 120 can optionally be placed on top of the coated additive delivery laminate 116, to prevent blocking. In another optional step, the dried additive delivery laminate can be backseamed in backseaming apparatus 122 before it is wound up onto windup roll 118.

The additive delivery laminate can be used in a process in which a forming web and a non-forming web are fed from two separate rolls, with the forming web being fed from a roll mounted on the bed of the machine for forming the package “pocket,” i.e., the product cavity. The non-forming (lidstock) web is usually fed from a top-mounted arbor for completing the airtight top seal of the package. Each web has its meat-contact/sealant surface oriented towards the other, so that at the time of sealing, the sealant surfaces face one another. The additive delivery coating can be present on the meat-contact surface of one of both of the forming web and the non-forming web. The forming web can be indexed forward by transport chains, and a previously sealed package can pull the upper non-forming web along with the bottom web as the machine indexes the product stream forward.

The invention is illustrated by the following examples, which are provided for the purpose of representation, and are not to be construed as limiting the scope of the invention. Unless stated otherwise, all percentages, parts, etc. are by weight.

### Preparation of Substrate No. 1

A 18¾″ wide (lay-flat dimension) tube, called a “tape”, having a total thickness of about 27 mils, was produced by the coextrusion process described above and illustrated in FIG. 1, wherein the film cross-section (from inside to outside of the tube) was as follows:

TABLE 1

| | | Layer |
|---|---|---|
| Layer Function(s) | | Thickness |
| and Arrangement | Layer Composition | (mils) |
| Seal | LLDPE#1 | 6.6 |
| strength and | blend of 80% EVA#1 and 15% | 2.7 |
| balance | HDPE#1 and 5% Blue MasterBatch | |
| Tie | anhydride-grafted LLDPE#2 | 1.7 |
| strength and | blend of 50% Nylon#1 and 50% | 0.8 |
| moisture barrier | Nylon#2 | |
| O₂-barrier | 100% EVOH | 1.0 |
| Tie | anhydride-grafted LLDPE#2 | 2.8 |
| strength and | blend of 80% EVA#1 and 15% | 6.4 |
| balance | HDPE#1 and 5% Blue MasterBatch | |
| Outside | blend of 90% LLDPE#1 and 10% | 5.0 |
| | Silica Antiblock | |

wherein:
LLDPE#1 was DOWLEX 2244A, linear low density polyethylene, obtained from Dow Plastics, of Freeport.
EVA#1 was PE 1651CS28 (TM) ethylene vinyl acetate copolymer, obtained from Hunstman;
HDPE#1 was FORTIFLEX T60-500-119 high density polyethylene, obtained from BP;
Blue MasterBatch was 16517-18 Blue, blue pigment in LLDPE carrier, obtained from Colortech.
Anhydride-grafted LLDPE#2 was PX3227 linear low density polyethylene having an anhydride functionality grafted thereon, obtained from Equistar;
EVOH was EVAL LC-E105A polymerized ethylene vinyl alcohol, obtained from Eval Company of America, of Lisle, Illinois;
NYLON#1 was ULTRAMID B4 polyamide 6, obtained from BASF corporation of Parsippany, New Jersey;
NYLON#2 was GRILON CF6S polyamide 6/12, obtained from EMS-American Grilon Inc., of Sumter, S.C.; and
Silica Antiblock was 10853 silica in LLDPE from Ampacet.

All the resins were coextruded at between 380° F. and 500° F., and the die was heated to approximately 420° F. The extruded annular tape was cooled with water and placed in a lay-flat configuration, and had a width of 18¾ inches. The tape was then passed through a scanned beam of an electronic cross-linking unit, where it received a total passage of about 64 kilo grays (kGy). After irradiation, the lay-flat tape was passed through steam (approximately 238° F. to 242° F.) for about 60 seconds. The resulting heated tape was inflated into a bubble and oriented 2.6× in the longitudinal direction (i.e., machine direction) and 3.8× in the transverse direction (while the tape was at a temperature above the Vicat softening point of one or more of the polymers therein, but while the polymers remained in the solid state) into a film tubing which was then placed in lay-flat configuration. The lay-flat film tubing had a lay-flat width of 63½ inches and a total thickness of about 2.7 mils. The film was annealed. The bubble was stable and the optics and appearance of the film were good. The film tubing was determined to have about 10% free shrinkage in the longitudinal direction and about 12% free shrinkage in the transverse direction, when immersed in hot water for about 10 minutes, the hot water being at a temperature of 185° F., i.e., using ASTM method D2732-83. The resulting tubing was slit into film.

### Preparation of Substrate No. 2

A 2.4 mil film was made by slitting a tubing made by the process of FIG. 1. The tubing had the following structure:

TABLE 2

| Layer Function(s) | | Layer Thickness |
|---|---|---|
| and Arrangement | Layer Composition | (mils) |
| inside and seal | EPC #1 | 0.53 |
| bulk | VLDPE#1 | 0.51 |
| tie | anhydride-grafted LLDPE#2 | 0.15 |
| O₂-barrier | EVOH | 0.17 |
| tie | anhydride-grafted LLDPE#2 | 0.15 |
| abuse and bulk | blend of 90% EVA#1 and 10% | 0.97 |
| | HDPE#1 | |

EPC#1 was ProFax SA861 ethylene propylene copolymer, obtained from Bassel.
VLDPE#1 was Exact 3128 single site very low density polyethylene from Exxon;

Otherwise, each of the resins was as identified in Substrate No. 1, above.

### Preparation of Substrate No. 3

A 18¾″ wide (lay-flat dimension) tube, called a “tape”, was produced by the coextrusion process described above and illustrated in FIG. 1, wherein the film cross-section (from inside to outside of the tube) was as follows:

TABLE 3

| Layer Function(s) | | Layer Thickness |
|---|---|---|
| and Arrangement | Layer Composition | (mils) |
| seal | LLDPE#1 | 6.6 |
| strength | blend of 80% EVA#1 and 20% | 2.7 |
| | HDPE#1 | |
| tie | anhydride-grafted LLDPE#2 | 1.7 |
| strength and | blend of 50% Nylon#1 and 50% | 0.8 |
| moisture barrier | Nylon#2 | |
| O₂-barrier | 100% EVOH | 1.0 |
| tie | anhydride-grafted LLDPE#2 | 2.8 |
| strength and | blend of 80% EVA#1 and 20% | 6.4 |
| balance | HDPE#1 | |
| outside | blend of 90% LLDPE#1 and 10% | 5.0 |
| | Silica Antiblock | |

In each of the various layers of Substrate No. 3, each of the components are identified above in the description of Substrate No. 1.

All the resins were coextruded at between 380° F. and 500° F., and the die was heated to approximately 420° F. The extruded tape was cooled with water and flattened, the flattened width being 18¾ inches wide in a lay flat configuration. The tape was then passed through a scanned beam of an electronic cross-linking unit, where it received a total passage of about 64 kilo grays (kGy). After irradiation, the flattened tape was passed through steam (approximately 238° F. to 242° F.) for about 60 seconds. The resulting heated tape was inflated into a bubble and oriented (while the tape was at a temperature above the vicat softening point of one or more of the polymers therein, but while the polymers remained in the solid state) into a film tubing having a total thickness of about 2.7 mils. The bubble was stable and the optics and appearance of the film were good. The resulting tubing was slit into film.

### EXAMPLES 1-5

### Preparation of Five Additive Transfer Laminates

A portion of Exxon Vistanex™ MM grade L-120 polyisobutylene (PIB) was removed from a bale and cut into small pellet-sized pieces. The MM grades of PIB rubber could be easily cut with a rubber bale cutter or even a band saw. It could also be shredded by powerful machinery suitable for rubber, such as a Mitts & Merrill Wood Hog or a Cumberland Plastics Granulator. A 10 weight percent solution of the PIB rubber and 0.1 wt. % Foral® AX hydrogenated rosin was prepared with 50 grams of the cut up rubber placed in a sealed glass jar with 450 grams of Isopar™ C (a petroleum fraction containing various hydrocarbons, but primarily composed of isooctane). The mixture was heated (to approximately 75° C.) and agitated until the butyl rubber and hydrogenated rosin was fully dissolved in the Isopar™ C organic solvent. The amount of rubber in solution could be varied from less than 10 wt. % to more than 25 wt. % in preparing an additive delivery slurry capable of providing acceptable results. To the 10 wt. % PIB rubber/1 wt. % hydrogenated rosin solution was added various quantities of granular color, flavor, and/or odor additives, with slow stirring to create a slurry of the granular additives in the solution of polyisobutylene and hydrogenated rosin. About a 2.5:1 mixture of powdered smoke to rubber can be use to provide the correct viscosity and level of flavorant. A variety of formulations were made to produce different flavor and color effects. This entire slurry was then stirred to provide a homogeneous dispersion. Table 4, below, identifies the various materials used to make up five different additive delivery formulations, each containing polyisobutylene and hydrogenated rosin dissolved in Isopar™ C solvent lists some examples of compositions using such materials but are not limited to them that impart desirable characteristics. with varying amounts smoke powder and caramel color powder.

TABLE 4

| | Example Number | | | | |
|---|---|---|---|---|---|
| | 1 | 2 | 3 | 4 | 5 |
| Material | Parts By Weight | | | | |
| 10 wt. % Vistanex ™ MM grade L- | 10 | 10 | 10 | 10 | 10 |
| 120 in Isopar ™ C | | | | | |
| Foral ® AX (Pinova Div. of | 0.1 | 0.1 | 0.1 | 0.1 | 0.1 |
| Hercules Inc.) | | | | | |
| Calcium oxide | 0 | 0 | 0 | 0 | 0.05 |
| D-040 powdered smoke (Red | 2.5 | 0 | 2.08 | 2.5 | 2.5 |
| Arrow) | | | | | |
| Caramel #602 (D. D. Williamson) | 0 | 2.5 | 0 | 0 | 0 |
| Caramel #603 (D. D. Williamson) | 0 | 0 | 0.42 | 0 | 0 |
| Caramel #608 (D. D. Williamson) | 0 | 0 | 0 | 0.53 | 0 |

The compositions in Table 4, above, were drawn down using an adjustable coating rod (described below) set at 4 mils onto the seal layer of a film very similar to Substrate No. 1, described above. The resulting wet coatings were allowed to air dry. All the compositions in Table 4 dried to a coating that had good adhesion and abuse characteristics as measured by 600-tape adhesion, fingernail scrape resistance and “crinkle” resistance.

The tape adhesion test was conducted using #600 tape produced by 3M. The sample tested was graded from 1 to 5, with 5 being no removal of the additive delivery coating. The adhesive side of the tape was manually pressed against the additive delivery coating, with the tape thereafter being pulled off of the additive delivery coating. In order to pass this test, the additive delivery layer had to exhibit 100 percent adhesion, i.e., there should be no visible removal of additive delivery layer from the substrate and onto the #600 tape.

The fingernail scrape resistance test was conducted by scraping across the additive delivery layer with the fingernail. If the coating is readily removed by the scraping action of the fingernail, the laminate fails the fingernail scrape resistance test.

Crinkle was tested using a sample which had been allowed to cure (i.e., dry) for at least 24 hours. Crinkle was conducted by crinkling the sample film between hands 10 times (or until heat is generated). The sample is then laid flat and inspected for disruption of the coating's surface, with any more than slight removal of the coating being considered as failing the test.

The additive delivery laminates of Examples 1-5 was used to package meat which was then cooked while packaged. The additive delivery laminates of Examples 1-5 transferred the color and/or smoke flavor to meat at cook-in conditions with little or no amount of the binder transferring to the cooked meat product. It was also discovered that addition of a base (e.g., calcium oxide) to the coating formulation (e.g., Example 5) reduced binder transfer to the meat, especially on some types of meat product (e.g. turkey), compared to additive delivery layers without the base (e.g., Example 1).

### EXAMPLES 6-20

A variety of coating formulations were prepared and thereafter applied to Substrate Film No. 1, described above, to make an additive delivery laminate. The additive delivery laminate was converted to a packaging article by being heat sealed to itself to form a casing, which was then used to package a food product. The food product was then cooked while packaged in the additive delivery laminate. During cooking, one or more additives from the additive delivery layer transferred to the food product, imparting desired color, flavor, and/or fragrance to the food product.

More particularly, the coating formulations were prepared by combining organic solvent, water-insoluble thermoplastic polymer (i.e. polyisobutylene, which is a rubber), a polymer toughening agent (i.e., hydrogenated pine rosin, which is a tackifier) and one or more granular additive agents. In general, about a 1:4 mixture (weight basis) of granular flavor, color, and/or odorant agent(s) to polymer solution was made, resulting in a slurry having the desired viscosity and granular additive level. More particularly, the coating formulation was prepared by removing rubber material from a bale using a utility knife, rubber bale cutter or a band saw, with the rubber thereafter being chopped up using shredding machinery suitable for industrial processing of rubber, such as a Mitts & Merrill Wood Hog, a Cumberland Plastics Granulator, or a Banbury mixer. The Banbury mixer was useful when compounding release additives or other polymers to produce the rubber component of the coating slurry. The chopped rubber component and the hydrogenated pine rosin polymer toughening agent were both then dissolved in a Isopar™ C solvent, using heat and stirring, to create a rubber solution. The flavor, aroma, and/or color granules were then added to the solution of rubber and polymer toughening agent, to produce the slurry. The additive granules were added at a level of from about 20 to 70 percent, based on total weight of the rubber solution. However, the granules could have been added to the rubber solution at a still higher loading.

The resulting slurry was then applied to the seal layer of Substrate No. 1, above, using an adjustable coating applicator obtained from Gardner Lab, Inc., of Bethesda, Md. The stainless steel adjustable coating applicator was made from a rod having a machined groove that tapered from 0 to 10 mil in depth by 8 inches in width. The coating gap was set by aligning marks on steel plates attached by curl nuts on each end of the adjustable coating rod, with the desired gap being marked on the edges of the rod. The coating applicator had a width 8 inches, and was adjustable to apply a coating of from 0 to 10 mils. The applicator was adjusted to apply a coating having a thickness of 4 mils onto Substrate No. 1. As Substrate No. 1 had been slit to a width of approximately 12 inches and the coating applicator was used to apply an 8-inch wide coating to the central portion of the film, Substrate No. 1 was left with uncoated edge portions each of which was about 2 inches in width.

After the coating formulation was applied to the film, it was allowed to air dry, resulting in the additive delivery laminate. Once dried, all of the formulations in Table 5 exhibited good adhesion to Substrate No. 1 and good abuse characteristics. Although air drying of the solvent was utilized, solvent evaporation could have been accelerated by placing the coated substrate in a drying oven. After drying, the granules were present in the dried additive layer at a level of from about 50 to about 85 weight percent, such as from 60 to 80 weight percent, or 70 to 75 weight percent, based on total weight of the additive delivery layer.

The additive delivery laminate was then backseamed with the coating facing inside the resulting tubing. The casing was closed at one end using a metal clip, and the food product (in Examples 6-20, a ham emulsion) was then loaded into the clipped casing after which the other end of the casing tubing was closed to form a packaged product.

While packaged in the casing, the food product was then cooked for 30 minutes at 55° C., followed by 30 minutes at 66° C., followed by 60 minutes at 72° C. After cooking, the product was cooled, and the casing removed from the cooked meat. The color and flavor/aroma in the additive transfer layer transferred to the meat during cooking. In none of Examples 6-20 was it found that the binder (e.g., Vistanex™ MM polybutylene) transferred to or adhered to the cooked meat product. Furthermore, none of the samples exhibited meat pick-off and/or legs due to binder adhesion to the cooked meat product. Depending upon the amount and grade of the colorant used, the resulting color on the meat ranged from light to very dark (see Examples 4-6 and 7-9), or from light to dark (see Examples 15-17 and 18-20). The flavor/aroma varied from weak to strong depending upon the amount of flavorant used (see Examples 7, 8, and 9). As can be seen from the results provided in Table 5, the polyisobutylene did not transfer to the meat product, as there was no “pick-off” and “legs” when removing the cooked meat product from the casing film.

TABLE 5
Example No.

| | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|
| Parts by weight | | | | | | | | | | | | | | | |
| 10 wt. % Vistanex ™ | 14.3 | 13.5 | 12.5 | 15.2 | 14.4 | 12.8 | 15.2 | 14.4 | 12.8 | 15.2 | 14.4 | 12.8 | 15.2 | 14.4 | 12.8 |
| MM grade L120 | | | | | | | | | | | | | | | |
| and | | | | | | | | | | | | | | | |
| 1 wt. % Foral ® DX | | | | | | | | | | | | | | | |
| in Isopar ™ C | | | | | | | | | | | | | | | |
| D-040 powdered | 0.75 | 1.5 | 3.13 | | | | | | | | | | | | |
| smoke (Red Arrow) | | | | | | | | | | | | | | | |
| Caramel #602 | | | | | | | 0.8 | 1.6 | 3.2 | | | | | | |
| (D. D. Williamson) | | | | | | | | | | | | | | | |
| Caramel #603 | | | | 0.8 | 1.6 | 3.2 | | | | | | | | | |
| (D. D. Williamson) | | | | | | | | | | | | | | | |
| Caramel #608 | | | | | | | | | | 0.8 | 1.6 | 3.2 | | | |
| (D. D. Williamson) | | | | | | | | | | | | | | | |
| Caramel #624 | | | | | | | | | | | | | 0.8 | 1.6 | 3.2 |
| (D. D. Williamson) | | | | | | | | | | | | | | | |
| meat type | H | H | H | H | H | H | H | H | H | H | H | H | H | H | H |
| (H = ham emulsion) | | | | | | | | | | | | | | | |
| Cook-in Results | | | | | | | | | | | | | | | |
| Color | weak | some | some | Light | Dark | very | light | dark | very | light | light | dark | light | light | Dark |
| | | | | | | dark | | | dark | | | | | | |
| Flavor | weak | fair | strong | Not | Not | not | not | not | not | not | not | not | not | not | not |
| | | | | tested | tested | tested | tested | tested | tested | tested | tested | tested | tested | tested | tested |
| Pick-off/legs | no | no | no | No | No | no | no | no | no | no | no | no | no | no | No |

### EXAMPLES 21-40

Table 6, below, provides cook-in results for Examples 21-40, in which various coating formulations were prepared and applied to Substrate No. 1 in a manner corresponding to the manner set forth in Examples 6-20. However, the formulations of Examples 21-40 differed by varying the composition of the polymer toughening agent as well as by inclusion of calcium oxide (i.e., a co-toughening agent and/or release agent) in some of the formulations. The resulting additive transfer laminates were converted to casings and used to package turkey emulsion, with the packaged products being subjected to cook-in as in Examples 6-20.

In general, it was observed that the polymeric toughening agents improved the cohesive strength of the polyisobutylene binder, and reduced the pick-offlegs from the polyisobutylene upon/during removal of the casing from the cooked turkey product after cook-in. Materials such as Staybelite A and rosin esters including Foral® AX, DX, NC and Endere® S served as polymer toughening agents. All of the compositions dried to a coating having good adhesion and abuse characteristics. The color and aroma was transferred to the meat at cook-in conditions. In general, it was observed that there were fewer or no pick-off/legs with the tackifiers, especially when used in conjunction with calcium oxide when the meat was turkey. It was also observed that the grade of the colorant could have an effect on the performance of the coating.

TABLE 6

| | Example No. | | | | | | | | | |
|---|---|---|---|---|---|---|---|---|---|---|
| | 21 | 22 | 23 | 24 | 25 | 26 | 27 | 28 | 29 | 30 |
| parts by weight | | | | | | | | | | |
| 10 wt. % Vistanex | 10 | 10 | 10 | 10 | 10 | 10 | 10 | 10 | 10 | 10 |
| MM grade L120 | | | | | | | | | | |
| in Isopar ™ C | | | | | | | | | | |
| Foral ® AX | 0.1 | | | | | 0.1 | | 0.1 | | |
| Foral ® DX | | 0.1 | | | | | 0.1 | | 0.1 | |
| Endere S | | | 0.2 | | | | | | | |
| Foral NC | | | | 0.1 | | | | | | |
| Staybelite A | | | | | 0.1 | | | | | |
| Calcium Oxide | | | | | | 0.05 | 0.05 | | | |
| D-040 powdered | 2.5 | 2.5 | 2.5 | 2.5 | 2.5 | 2.5 | 2.5 | 2.5 | 2.5 | 2.5 |
| smoke (Red Arrow) | | | | | | | | | | |
| Caramel #603 | 0.53 | 0.53 | 0.53 | 0.53 | 0.53 | 0.53 | 0.53 | 0.53 | | |
| (D. D. Williamson) | | | | | | | | | | |
| Caramel #624 | | | | | | | | | 0.53 | 0.53 |
| (D. D. Williamson) | | | | | | | | | | |
| meat type | T | T | T | T | T | T | T | T | T | T |
| (T = turkey emulsion) | | | | | | | | | | |
| Cook-in Results | | | | | | | | | | |
| Color | good | good | good | good | good | Good | Good | good | good | good |
| Flavor | good | good | good | good | good | Good | Good | good | good | good |
| Pick-off/legs | some | few | few | Few | few | No | No | few | few | few |
| | Example No. | | | | | | | | | |
| | 31 | 32 | 33 | 34 | 35 | 36 | 37 | 38 | 39 | 40 |
| parts by weight | | | | | | | | | | |
| 10 wt. % Vistanex | 10 | 10 | 10 | 10 | 10 | 10 | 10 | 10 | 10 | 10 |
| MM grade L120 | | | | | | | | | | |
| in Isopar ™ C | | | | | | | | | | |
| Foral ® AX | | | | 0.1 | | | 0.1 | 0.1 | 0.1 | 0.1 |
| Foral ® DX | | | | | 0.1 | | | | | |
| Endere S | 0.2 | | | | | | | | | |
| Foral NC | | 0.1 | | | | | | | | |
| Staybelite A | | | 0.1 | | | | | | | |
| Calcium Oxide | | | | 0.05 | 0.05 | | 0.05 | 0.05 | 0.05 | 0.05 |
| D-040 powdered | 2.5 | 2.5 | 2.5 | 2.5 | 2.5 | 2.5 | 2.5 | 2.5 | 2.5 | 2.5 |
| smoke (Red Arrow) | | | | | | | | | | |
| Caramel #603 | | | | | | | 0.53 | 0.4 | 0.26 | 0.13 |
| (D. D. Williamson) | | | | | | | | | | |
| Caramel #624 | 0.53 | 0.53 | 0.53 | 0.53 | 0.53 | 0.53 | | | | |
| (D. D. Williamson) | | | | | | | | | | |
| meat type | T | T | T | T | T | T | T | T | T | T |
| (T = turkey emulsion) | | | | | | | | | | |
| Cook-in Results | | | | | | | | | | |
| Color | good | good | good | good | good | good | good | good | fair | poor |
| Flavor | good | good | good | good | good | good | good | good | good | good |
| Pick-off/legs | some | some | some | no | no | some | no | no | no | no |

### EXAMPLES 41-44

Table 7, below, provides cook-in results for Examples 41-44, in which various coating formulations were prepared and applied to Substrate No. 1 in the same manner as set forth in Examples 6-20. The resulting coated films were used to package a variety of different types of meat emulsions, with the packaged products being subjected to cook-in as in Examples 6-20.

The cook-in results revealed that different meat types behave differently when cooked using the same or similar flavor and/or color compositions in accordance with the present invention. Basic compounds such as calcium oxide were found to improve desired cook-in properties with certain meat types (e.g., turkey, as in Example 42), while being detrimental with respect to the same cook-in property for other meat types (e.g., ham, as in Example 41).

All of the compositions dried to a coating which exhibited good adhesion and abuse characteristics. The color and/or smoke flavor transferred to the meat at cook-in conditions with reduced amount of binder transferring (and reduced legs) to the turkey and beef meat products, but with significantly more pick-off/legs with the ham product.

TABLE 7

| | Example No. | | | |
|---|---|---|---|---|
| | 41 | 42 | 43 | 44 |
| Parts by weight | | | | |
| 10 wt. % Vistanex ™ MM grade L120 in | 10 | 10 | 10 | 10 |
| Isopar ™ C | | | | |
| Foral ® AX | 0.1 | 0.1 | 0.1 | 0.1 |
| Calcium Oxide | 0.05 | 0.05 | | 0.05 |
| D-040 powdered smoke (Red Arrow) | 2.5 | 2.5 | 2.5 | |
| Caramel #603 (D. D. Williamson) | | | | 2.5 |
| meat type | H | T | T | B |
| Cook-in Results | | | | |
| Color | good | good | good | good |
| Flavor | good | good | good | not |
| | | | | tested |
| Pick-off/legs | many | no | some | No |

H = Ham Emulsion;
T = Turkey Emulsion;
B = Beef Emulsion

### EXAMPLES 45-56

Table 8, below, provides cook-in results for Examples 45-56, in which various coating formulations were prepared and applied to Substrate No. 1 in the same manner as set forth in Examples 6-20. However, the formulations of Examples 45-56 differed in that they did not contain flavor/aroma additives. The resulting coated films were converted to casings and then used to package ham emulsion, turkey emulsion, and beef emulsion, with the packaged products thereafter being subjected to cook-in as in Examples 6-20.

The cook-in results revealed that the meat which was cooked in the uncoated film (i.e., Examples 51, 52, and 53) exhibited meat adhesion and legs, indicating that these undesirable characteristics may not be from the polybutylene binder alone (compare the results of Examples 51-53 with the results of Examples 45-50). It is believed that this result occurred because the film of Substrate No. 1 was corona treated, producing polar sites on the surface of the seal layer, causing excessive adhesion of the film to the meat product.

TABLE 8
Example No.

| | 45 | 46 | 47 | 48 | 49 | 50 | 51 | 52 | 53 | 54 | 55 | 56 |
|---|---|---|---|---|---|---|---|---|---|---|---|---|
| Parts by weight | | | | | | | | | | | | |
| 10 wt. % Vistanex MM grade | 10 | 10 | 10 | 10 | 10 | 10 | None | None | None | 10 | 10 | 10 |
| L120 in Isopar ™ C | | | | | | | | | | | | |
| Calcium Oxide | 0.05 | 0.05 | 0.05 | | | | | | | | | |
| Citric Acid | | | | | | | | | | 0.05 | 0.05 | 0.05 |
| meat type | H | T | B | H | T | B | H | T | B | H | T | B |
| Cook-in Results | | | | | | | | | | | | |
| Pick-off/legs | few | very few | very few | few | Very few | very few | adhesion/ | adhesion/ | adhesion/ | few | no | Some |
| | | | | | | | legs | legs | legs | | | |

H = Ham Emulsion;
T = Turkey Emulsion;
B = Beef Emulsion

### EXAMPLES 57-66

Table 9, below, provides the coating composition and cook-in results for Examples 57 to 66, in which various coating formulations were prepared and applied to the base film in the same manner as set forth in Examples 6-20. Each of the coating formulations in Examples 57-66 contained the same type and amount of polybutylene and organic solvent (i.e., 10% Vistanex™ MM grade L120 polybutylene in Isopar™ C), the same type and amount of polymer toughening agent (Foral® AX hydrogenated rosin), the same type and amount of powdered smoke (D-040 powdered smoke), and the same type and amount of caramel (Caramel #603). However, the coatings on Examples 57-59 further contained various amounts of talc (Vantalc F2300); the coatings on Examples 60-62 further contained various amounts of mica (Alsibronz 10); the coatings of Examples 63-65 further contained various amounts of silica (Aerosil 200). The coating of Example 66 contained no such inorganic additive. The resulting coated films were converted to casings and used to package ham emulsion, with the packaged products being subjected to cook-in as in Examples 6-20.

Table 9 provides the cook-in results. The color and aroma transferred to the meat product at cook-in conditions. However, as is apparent from a comparison of the results using the inorganic additive (i.e, the results of Examples 57-65) with Example 66 (i.e., the control which did not include any talc, mica, or silica, or other inorganic additive, there was no improvement in color, aroma, or pick-off/legs. Moreover, one of the inorganic additives (i.e., Aerosil 200) degraded the desired color and pick-off/legs.

TABLE 9

| | Example No. | | | | | | | | | |
|---|---|---|---|---|---|---|---|---|---|---|
| | | | | | | | | | | 66 |
| | 57 | 58 | 59 | 60 | 61 | 62 | 63 | 64 | 65 | (control) |
| parts by weight | | | | | | | | | | |
| 10 wt. % Vistanex ™ MM grade | 10 | 10 | 10 | 10 | 10 | 10 | 10 | 10 | 10 | 10 |
| L120 in Isopar ™ C | | | | | | | | | | |
| Foral ® AX | 0.1 | 0.1 | 0.1 | 0.1 | 0.1 | 0.1 | 0.1 | 0.1 | 0.1 | 0.1 |
| D-040 powdered smoke (Red Arrow) | 2.08 | 2.08 | 2.08 | 2.08 | 2.08 | 2.08 | 2.08 | 2.08 | 2.08 | 2.08 |
| Caramel #603 (D. D. Williamson) | 0.42 | 0.42 | 0.42 | 0.42 | 0.42 | 0.42 | 0.42 | 0.42 | 0.42 | 0.42 |
| Vantalc F2003 (R. T. Vanderbilt) | 0.05 | 0.1 | 0.15 | | | | | | | |
| Alsibronz 10 (Engelhard Corp.) | | | | 0.05 | 0.1 | 0.15 | | | | |
| Aerosil 200 (Degussa) | | | | | | | 0.05 | 0.1 | 0.15 | |
| meat type | H | H | H | H | H | H | H | H | H | H |
| H = Ham Emulsion | | | | | | | | | | |
| Cook-in Results | | | | | | | | | | |
| Color | good | good | good | good | good | good | spotty | spotty | spotty | good |
| Aroma | good | good | good | good | good | good | good | good | good | good |
| Pick-off/legs | little | little | little | little | little | little | some | some | some | little |

### COMPARATIVE EXAMPLE 67

A 10% solution of base polymer (polyisobutylene, i.e, PIB) was prepared by stirring 1 gram of polyisobutylene into 10 grams of aliphatic solvent. The solution contained no additive granules. The solution was applied by hand to a thermoplastic polymeric substrate, and metered using a 4 mil clearance adjustable coating rod. The coated substrate was air dried overnight to produce a coated substrate. The coated substrate was cross-sectionally gauged using a Zeiss optical microscope at 400×. Twenty sites were measured and the average coating thickness was recorded. The mean thickness was observed to be 0.3 mils.

### EXAMPLES 68 AND 69

Two additive delivery layers of laminates according to the invention were cross-sectionally gauged using a Zeiss optical microscope at 400× magnification. The substrate and additive delivery formulation used to make the additive delivery laminate of Example 68 corresponds with Example 3, above, and was a coating exhibiting a uniform distribution of additive particles, i.e., a homogeneous coating. In the preparaton of the additive delivery laminate of Example 68, the additive delivery slurry that was twice sheared in a high shear mixer (i.e., a fluid media mill) prior to application to the substrate, in order to break up particle agglomerates. In contrast, the additive delivery laminate of Example 69 (having a formulation also corresponding with Example 3, above) was produced by coating a non-uniform distribution of additive particles onto a substrate, without the big shear mixing of the slurry, i.e., to produce a relatively heterogeneous coating. Otherwise, the additive delivery laminates of Examples 68 and 69 were produced by similar processes.

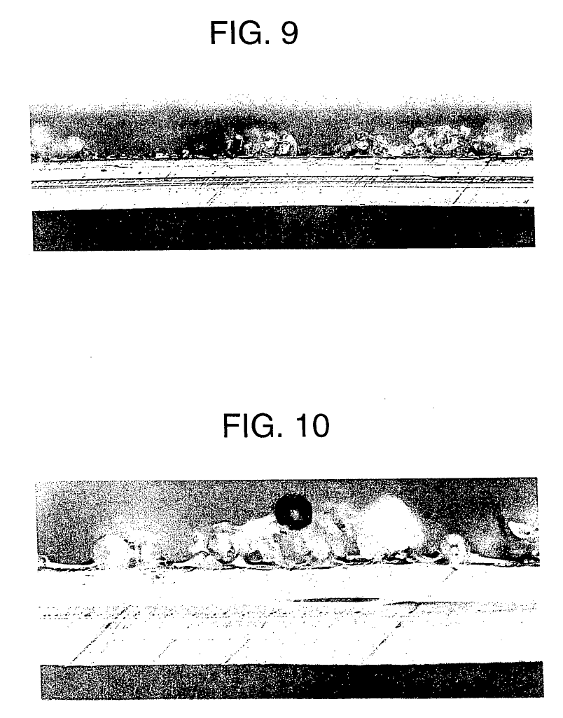

FIG. 9 illustrates a typical cross-sectional view through the additive delivery layer of Example 68. FIG. 10 illustrates a typical cross-sectional view through the additive delivery layer of Example 69. As can be seen by comparing FIG. 9 and FIG. 10, the heterogeneous coating of Example 69 had a much greater surface roughness than the relatively homogeneous coating of Examle 69.

For Example 68, twenty sites were measured for thickness (i.e., height) in areas of the heterogeneous coating having only the base polymer present, and twenty sites in areas containing base polymer and water soluble additive delivery particles were also measured. The same measurements were taken for the additive delivery laminate of Example 69.

The microscopic gauging reflects the heterogeneity of the coating according to Example 69, versus the relatively homogeneous coating application obtained from the high shear preparation resulting in the additive delivery layer of Example 68. Heterogeneous coatings provide a matt finish on cooked foods, and may be more desirable in certain applications than a homogeneous coating application. As reported in Table 10 below, the mean coating layer thickness for the heterogeneous coating of Example 69 was about 1.6 mils in areas having additive particles, whereas the thickness of the coating in areas having no visible additive delivery particles, but rather having only the polyisobutylene thermoplastic, was only about 0.2 mils. This 8:1 gauge differential is indicative of the aggregate character of additive delivery coatings which exhibit a matt finish in cooked food surfaces. The mean coating thickness of the homogeneous additive delivery layer of Example 68 was about 1.2 mils.

The gauge differential between base coating and particle loaded areas in the a heterogeneous additive delivery coating (such as of Example 69) can be greater than 0.5 mils, such as greater than 0.75 mils, such as greater than 0.85 mils, or such as 2.0 mils. Mean coating differences between uncooked coated areas having no visible additive delivery particles and areas containing additive delivery particles in such heterogeneous additive delivery layers exhibiting a matt finish on cooked food surfaces, ranged from 0.5 mil to 2.5 mils, such 0.7 mil to 2.0 mils, or such as 0.8 mil to 1.0 mil. The ratio between mean thickness in areas where coating includes additive delivery particles and the mean thickness in areas substantially void of additive delivery particles can be from 2:1 to 10:1, such as between 3:1 to 8:1. In use, heterogeneous additive delivery layers may also provide better release both from adjacent sides of coated substrate which come into face to face contact, as well as better release from a cooked food surface when the substrate is removed from a cooked and cooled food product. Table 10, below, provides provides data showing the gauging results for Examples 68 and 69.

TABLE OF MICROSCOPIC GAUGING

| | | Example 68: | | | |
|---|---|---|---|---|---|
| | | Homogeneous | | Example 69 | |
| | Comparative | Coating | | Heterogeneous | |
| | Coating | (High Shear Coating) | | Coating | |
| | (Base Coating, | | Particle | | Particle |
| | PIB Only) | PIB | Loaded | PIB | Loaded PIB |
| | PIB Layer | Layer | PIB Layer | Layer | Layer |
| Minimum | 0.20 | No Data¹ | 1.00 | 0.12 | 1.06 |
| Maximum | 0.40 | No Data | 1.47 | 0.28 | 2.32 |
| Mean | 0.31 | No Data | 1.16 | 0.19 | 1.61 |
| Std. Dev. | 0.06 | — | 0.12 | 0.04 | 0.36 |

¹No sites were observed

What is claimed is:

1. An additive delivery laminate comprising:
(A) a substrate; and
(B) an additive delivery layer comprising:
(i) a water-insoluble thermoplastic polymer,
(ii) a polymer toughening agent in a blend with the thermoplastic polymer; and
(iii) additive granules comprising at least one member selected from the group consisting of colorant, flavorant, and odorant.

2. The additive delivery laminate according to claim 1, wherein the additive granules form at least a portion of a surface of the additive layer which is opposite the substrate.

3. The additive delivery laminate according to claim 1, wherein the water-insoluble thermoplastic polymer in the additive delivery layer comprises polyisobutylene.

4. The additive delivery laminate according to claim 3, wherein the polymer toughening agent comprises at least one member selected from the group consisting of hydrogenated wood rosin, silica, clay, talc, mica, and kaolin.

5. The additive delivery laminate according to claim 4, wherein the polymer toughening agent comprises hydrogenated wood rosin.

6. The additive delivery laminate according to claim 5, wherein the additive delivery layer further comprises calcium oxide.

7. The additive delivery laminate according to claim 5, wherein the hydrogenated wood rosin is present at a level of from about 0.3 to about 30 weight percent, based on the weight of the thermoplastic polymer in the additive delivery layer.

8. The additive delivery laminate according to claim 1, wherein the additive delivery layer is an outer layer of the laminate.

9. The additive delivery laminate according to claim 1, wherein the additive delivery layer further comprises a water-soluble polymer.

10. The additive delivery laminate according to claim 1, wherein the additive delivery layer comprises granules having a particle size of from about 10 to about 500 microns.

11. The additive delivery laminate according to claim 1, wherein some, but not all, of the additive granules are fully embedded in the thermoplastic polymer in the additive delivery layer.

12. The additive delivery laminate according to claim 1, wherein the granules are present in the additive layer at a level of from about 10 to about 90 weight percent, based on total weight of the additive delivery layer.

13. The additive delivery laminate according to claim 1, wherein the thermoplastic water-insoluble polymer in the additive delivery layer comprises at least one member selected from the group consisting of butadiene/styrene copolymer, isobutylene/isoprene copolymer, polyisoprene, polyisobutylene, ethylene/vinyl acetate copolymer, ethylene/butyl acrylate copolymer, ethylene/vinyl alcohol copolymer, ethylene/propylene copolymer, polybutadiene, polyethylene, ethylene/alpha-olefin copolymer, polypropylene, polyvinyl acetate, cellulose triacetate, natural rubber, chicle, and balata rubber.

14. The additive delivery laminate according to claim 1, wherein the granules comprise at least one member selected from the group consisting of caramel, powdered smoke, fried flavorant, roasted flavorant, grilled flavorant, turkey pan drippings flavorant, and encapsulated smoke oil.

15. The laminate according to claim 1, wherein the additive delivery layer further comprises crosslinked butyl rubber.

16. The laminate according to claim 1, wherein the additive delivery layer contains a blend comprising polyisobutylene and crosslinked butyl rubber.

17. The laminate according to claim 1, wherein the substrate comprises a thermoplastic polymer selected from the group consisting of polyethylene, ethylene/alpha-olefin copolymer, polypropylene, propylene/alpha-olefin copolymer, ethylene/vinyl acetate copolymer, ethylene/ethylenically-unsaturated esters, ethylene/alpha, beta-unsaturated carboxylic acid, ethylene/alpha, beta-unsaturated carboxylic acid anhydride, metal base neutralized salt of ethylene/alpha, beta-unsaturated carboxylic acid, ethylene/cyclo-olefin copolymer, ethylene/vinyl alcohol copolymer, polyamide, co-polyamide, polyester, co-polyester, polystyrene, and cellulose.

18. The laminate according to claim 1, wherein the laminate exhibits a total free shrink at 85° C. of at least 10 percent.

19. The laminate according to claim 1, wherein the laminate exhibits a total free shrink at 85° C. of less than 10 percent.

20. The laminate according to claim 1, wherein the substrate comprises thermoplastic polymer which is heat sealable.

21. The laminate according to claim 1, wherein the additive delivery layer further comprises a release agent comprising at least one member selected from the group consisting of petroleum wax, paraffin, beeswax, amide wax, antifog agent, vegetable oil, lard, mineral oil, oxidized polyethylene, silicone, polysiloxane, starch, and cellulose-based polymer.

22. The laminate according to claim 1, wherein the substrate comprises a multilayer film comprising:
(A) a heat seal layer comprising at least one member selected from the group consisting of olefin homopolymer, ethylene/alpha-olefin copolymer, ethylene/unsaturated ester copolymer, and ionomer resin; and
(B) an O₂-barrier layer comprising at least one member selected from the group consisting of ethylene/vinyl alcohol copolymer, polyvinylidene chloride, vinylidene chloride/methyl acrylate copolymer, vinylidene chloride/vinyl chloride copolymer, polyamide, polyester, polyacrylonitrile, and polycarbonate.

23. The laminate according to claim 22, further comprising:
(C) a first tie layer between the heat seal layer and the O₂-barrier layer;
(D) an outer abuse layer; and
(E) a second tie layer between the outer abuse layer and the O₂-barrier layer.

24. The laminate according to claim 23, further comprising a moisture barrier layer comprising polyamide, the moisture barrier layer being between first tie layer and the second tie layer.

25. The laminate according to claim 1, wherein the additive delivery layer is present in an amount of from about 5 to about 50 grams per square meter.

26. A packaging article comprising a laminate which is adhered to itself or another component of the packaging article, wherein the laminate comprises:
(A) a substrate; and
(B) an additive delivery layer comprising:
(i) a thermoplastic polymer, and
(ii) additive granules comprising at least one member selected from the group consisting of colorant, flavorant, and odorant; and
(iii) a polymer toughening agent.

27. The packaging article according to claim 26, wherein the packaging article comprises a member selected from the group consisting of bag, pouch, casing, tray, and lid.

28. The packaging article according to claim 27, wherein the packaging article comprises a casing selected from the group consisting of seamless casing, fin-sealed backseamed casing, lap-sealed backseamed casing, and butt-sealed backseamed casing with backseaming tape thereon.
